(19) United States
(12) Patent Application Publication
(10) Pub. No.: US 2025/0031105 A1
(43) Pub. Date: Jan. 23, 2025

(54) CONDITIONAL LAYER 1/LAYER 2 TRIGGERED MOBILITY IN WIRELESS SYSTEMS

(71) Applicant: Samsung Electronics Co., Ltd., Suwon-si (KR)

(72) Inventor: Shiyang Leng, Allen, TX (US)

(21) Appl. No.: 18/759,488

(22) Filed: Jun. 28, 2024

Related U.S. Application Data
(60) Provisional application No. 63/527,260, filed on Jul. 17, 2023.

(51) Int. Cl. H04W 36/00; H04B 7/06; H04W 56/00; H04W 76/20

(52) U.S. Cl. CPC H04W 36/0058; H04B 7/0695; H04W 36/00835; H04W 56/0045; H04W 76/20

(57) ABSTRACT

Techniques for performing a conditional low-layer triggered mobility (CLTM) are disclosed. A UE may receive, from a current serving cell, for each of a respective one or more candidate target cells, (i) a cell configuration, (ii) at least one corresponding physical layer (L1) measurement configuration, and (iii) at least one execution condition. The UE performs, using the L1 measurement configurations, L1 measurements for the candidate target cells. The UE evaluates, based on one or more L1 measurement results, the execution condition corresponding to one or more candidate target cells. Based upon evaluating that the execution condition corresponding to a candidate target cells is met, the UE determines the target cell as a new serving cell and selects a beam for the new serving cell based on one or more of the L1 measurements. The UE detaches from the current serving cell to apply the configuration of the new serving cell.

### CROSS-REFERENCE TO RELATED APPLICATIONS

This application claims the benefit of priority from U.S. Provisional Application No. 63/527,260 entitled “CONDITIONAL L1/L2 TRIGGERED MOBILITY,” filed Jul. 17, 2023, which is incorporated herein by reference in its entirety.

### TECHNICAL FIELD

This disclosure relates generally to a wireless communication system, and more particularly to, for example, but not limited to, conditional handovers for use in wireless mobility.

### BACKGROUND

Mobility management operations including network handovers represent a pivotal aspect of any wireless communication system. These systems include, for example, LTE and 5G New Radio (NR), and upcoming technologies currently coined “6G”. Mobility is presently controlled by the network with UE assistance to maintain optimal connection quality. The network may hand over the UE to a target cell with superior signal quality.

The inclusion of enhanced broadband mechanisms requiring high speeds and low latencies has necessitated more sophisticated handover mechanisms. Accordingly, conditional handovers (CHOs) and separately, layer 1/layer triggered mobility (LTM) have been introduced to provide additional conditions for specific networks or slices thereof to increase handover speed. The use of these enhancements, however, introduces latencies of its own, at least because the network needs to conduct several data exchanges with the UE during the handover process. The initiation of a prospective handover triggered by the network consequently introduces latencies, signaling overhead, and interruption times of its of its own.

The description set forth in the background section should not be assumed to be prior art merely because it is set forth in the background section. The background section may describe aspects or embodiments of the present disclosure.

### SUMMARY

An aspect of the disclosure provides a user equipment (UE). The UE includes a transceiver. The transceiver is configured to receive, from a serving cell, for each of a respective one or more candidate target cells, (i) a cell configuration, (ii) at least one corresponding physical layer (L1) measurement configuration, and (iii) at least one execution condition. The UE further includes a processor operably coupled to the transceiver. The processor is configured to perform, using the L1 measurement configurations, L1 measurements for the respective one or more candidate target cells. The processor is also configured to evaluate, based on one or more of the L1 measurements, the at least one execution condition corresponding to one or more candidate target cells. Based upon evaluating that the at least one execution condition corresponding to a candidate target cell is met, the processor is configured to determine the candidate target cell as a new serving cell. The processor is configured to select a beam for the new serving cell based on the one or more L1 measurements. The processor is configured to detach from the serving cell and apply the cell configuration corresponding to the new serving cell. The transceiver is further configured to transmit an uplink (UL) message to the new serving cell using the selected beam.

In some embodiments, when a timing advance (TA) is obtained for the new serving cell, the transceiver is further configured to transmit the message using the obtained TA via a random access channel (RACH)-less procedure, and the message is a first UL PUSCH.

In some embodiments, the at least one execution condition comprises one or more events of: an identified beam of the one or more evaluated candidate target cells having a measured L1 metric higher by an offset value than a beam of the serving cell; an identified beam of the one or more evaluated candidate target cells having a measured L1 metric that exceeds a threshold; or an identified beam of one or more of the evaluated candidate target cells having a measured L1 metric higher than a first threshold and a beam of the serving cell having a measured L1 metric lower than a second threshold. The measured L1 metric of the one or more evaluated candidate target cells for each of the one or more events corresponds to a value of the identified beam, or an average value of identified beams of the one or more evaluated candidate target cells.

In some embodiments, the transceiver is configured to apply the selected beam for the new serving cell based upon the one or more L1 measurements that correspond to the execution condition being met for the new serving cell.

In some embodiments, the transceiver is further configured to apply the selected beam for the new serving cell for use in a first downlink reception from the new serving cell.

In some embodiments, the processor is further configured to apply one or more of a joint transmission configuration indicator (TCI) state, a downlink (DL) TCI state, or an UL TCI state. For each of the one or more states, the reference signal is quasi-collocated to the selected beam. The transceiver is configured to perform one or both of (i) transmitting the (UL) message to the new serving cell based on the joint TCI state or the UL TCI state, or (ii) receiving a first DL message from the new serving cell based on the joint TCI state or the DL TCI state.

An aspect of the disclosure provides a method performed by a user equipment (UE). The method includes receiving, from a serving cell, for each of a respective one or more candidate target cells, (i) a cell configuration, (ii) at least one corresponding physical layer (L1) measurement configuration, and (iii) at least one execution condition. The method includes performing, using the L1 measurement configurations, L1 measurements for the respective one or more candidate target cells. The method includes evaluating, based on one or more of the L1 measurements, the at least one execution condition corresponding to one or more candidate target cells. Based upon evaluating that the at least one execution condition corresponding to a candidate target cell is met, the method includes determining the candidate target cell as a new serving cell. The method further includes selecting a beam for the new serving cell based on the one or more L1 measurements. The method also includes detaching from the serving cell and applying the cell configuration corresponding to the new serving cell. The method includes transmitting an uplink (UL) message to the new serving cell using the selected beam.

In some embodiments, the method includes transmitting the message via a random access procedure when a timing advance (TA) is not obtained for the new serving cell

In some embodiments, the method further includes transmitting the message using an obtained (TA) via a random access channel (RACH)-less procedure when the TA is obtained for the new serving cell.

In some embodiments, the at least one execution condition includes one or more events of an identified beam of the one or more evaluated target cells having a measured L1 metric higher by an offset value than a beam of the serving cell; an identified beam of the one or more evaluated candidate target cells having a measured L1 metric that exceeds a threshold; or an identified beam of one or more of the evaluated candidate target cells having a measured L1 metric higher than a first threshold and a beam of the serving cell having a measured L1 metric lower than a second threshold, the measured L1 metric of the one or more evaluated candidate target cells for each of the one or more events corresponding to a value of the identified beam, or an average value of identified beams of the one or more evaluated candidate target cells.

In some embodiments, the method further includes applying the selected beam for the new serving cell based upon the one or more L1 measurements that correspond to the execution being met for the new serving cell.

In some embodiments, the method further includes applying the selected beam for the new serving cell for use in a first downlink reception from the new serving cell.

In some embodiments, the method further includes applying one more of a joint transmission configuration indicator (TCI) state, a downlink (DL) TCI state, or an UL TCI state wherein for each of the one or more states, a reference signal is quasi-collated to the selected beam, and performing one or both of (i) transmitting the (UL) message to the new serving cell based on the TCI state or the UL TCI state, or (ii) receiving a first DL message from the new serving cell based on the TCI state of the DL TCI state.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows an example signaling diagram of a conditional handover procedure.

FIG. 5 shows an example signaling diagram of a procedure for Layer 1/2 Triggered Mobility (LTM).

FIG. 6 shows an example flow diagram of a conditional LTM (CLTM) operation of a UE in accordance with an embodiment.

FIG. 7 shows an example signaling diagram of a conditional LTM (CLTM) operation of a UE in accordance with an embodiment.

FIG. 8 shows an example flow diagram of a CLTM operation of a UE in accordance with an embodiment.

FIG. 9 shows a conceptual diagram illustrating two CLTM processes in a UE of a vehicle, in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic having dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHz, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

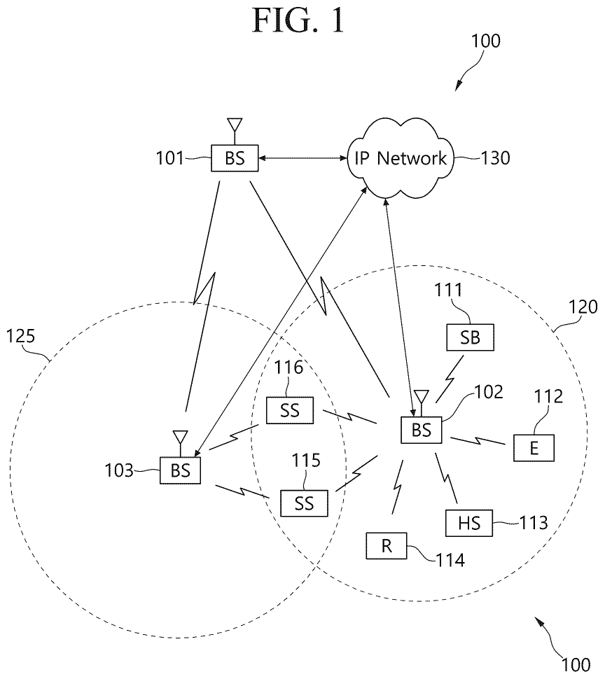

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with APs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or 103 can communicate directly with IP network 130 and provide UEs with direct wireless broadband access to the network 130. Further, gNB 101, 102, and/or 103 can provide access to other or additional external networks, such as external telephone networks or other types of data networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

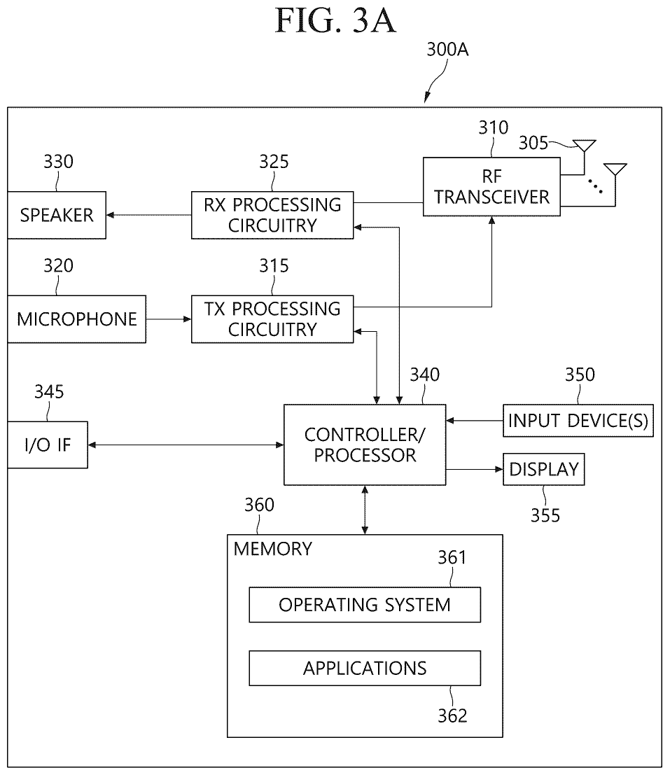

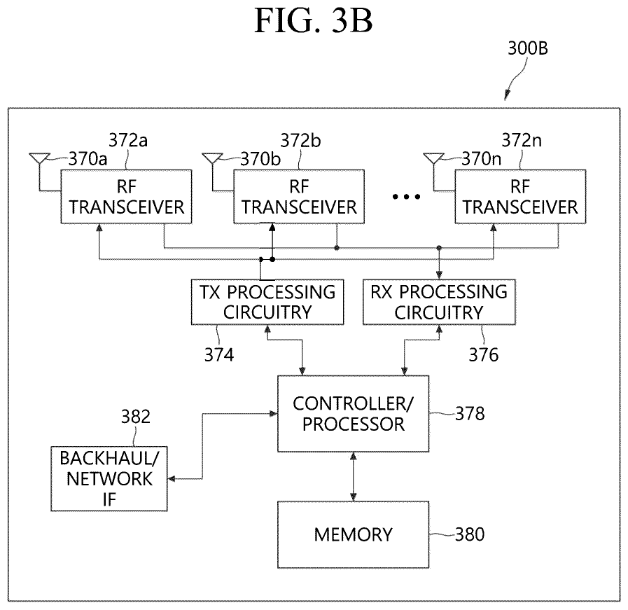

As shown with reference to FIG. 3B, below, the TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n.

The controller/processor can include one or more processors or other processing devices that control the overall operation of the BS 101 (FIG. 1). For example, the controller/processor may control the reception of uplink signals and the transmission of downlink signals by the UEs, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

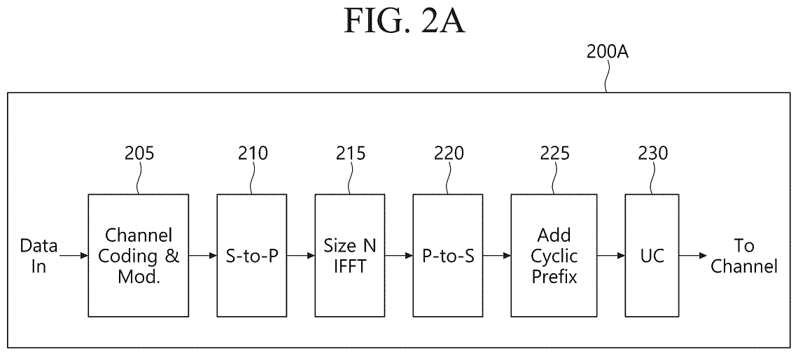

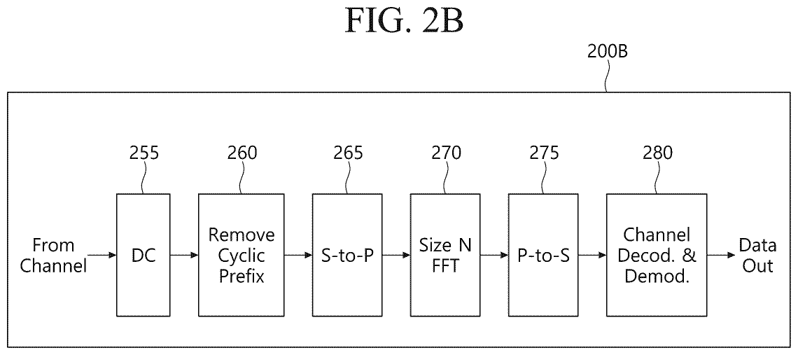

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1). The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory(ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 coupled to the processor 340, directly or through intervening elements. The main processor 340 is also capable of executing other processes and programs resident in the memory 360, such as CLTM in wireless communication systems as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. The main processor 340 is also coupled to the I/O interface 345, which provides the UE 300A with the ability to connect to other devices such as laptop computers and handheld computers. The I/O interface 345 is the communication path between these accessories and the main controller 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory, etc. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program, etc.) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting CLTM in wireless communication systems as described in embodiments of the present disclosure. In some embodiments, the controller/processor 378 supports communications between entities, such as web RTC. The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A, etc.), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning an uplink of transceiver to a certain frequency and establishing the downlink using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one transmission or receive per RF transceiver).

As an example, Release 13 of the LTE standard supports up to 16 CSI-RS [channel status information—reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel. 14 LTE. For next generation cellular systems such as 5G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power, etc.) and reports the results to the BS.

The BS 300B of FIG. 3B may also include additional or different types of memory 380, including dynamic random-access memory (DRAM), non-volatile flash memory, static RAM (SRAM), different levels of cache memory, etc. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms (e.g., CLTM, etc.) may be formulated by the inventors and designed to assist in providing an efficient description of the unique features within the disclosure. A list of both common and unique such acronyms follows.

### ABBREVIATIONS

L1 Layer 1
L2 Layer 2
L3 Layer 3
UE User Equipment
gNB Base Station
NW Network
NR New Radio
3GPP 3rd Generation Partnership Project
WI Work Item
SI Study Item
HO Handover
CHO Conditional Handover
DAPS Dual Active Protocol Stack
BFD Beam Failure Detection
BFR Beam Failure Recovery
SSB System Synchronization and PBCH Block
CSI Channel State Information
RS Reference Signal
TRP Transmit/Receive Point
PCell Primary Cell
SpCell Special Cell
SCell Secondary Cell
HARQ Hybrid ARQ
NDI New Data Indication
RRC Radio Resource Control
DU Distributed Unit
CU Central Unit
C-RNTI Cell Radio Network Temporary Identifier
CS-RNTI Configured Scheduling Radio Network Temporary Identifier
SPS Semi-Persistent Scheduling
SR Scheduling Request
UL-SCH Uplink Shared Channel
LCP Logical Channel Prioritization
PDU Protocol Data Unit
RSRP Reference Signal Received Power
SINR Signal to Interference and Noise Ratio
BLER Block Error Rate
CQI Channel Quality Indicator
TA Timing Advance
MIB Master Information Block
SIB System Information Block
CORESET Control Resource Set
RAR Random Access Response
DL Downlink
UL Uplink
DCI Downlink Control Information
PDCCH Physical Downlink Control Channel
PUSCH Physical Uplink Shared Channel
PUCCH Physical Uplink Control Channel
PUSCH Physical Downlink Shared Channel
SRS Sounding Reference Signal
PRACH Physical Random Access Channel
IE Information Element
TCI Transmission Configuration Indicator
RA Random Access
RAN Radio Access Network
5GC 5G Core Network
AMF Access Mobility Function
UPF User Plane Function
URLLC Ultra-Reliable Low Latency Communications
PDU Protocol Data Unit
MAC-CE Medium Access Control—Control Element
CFRE Contention-Free Random Access
PDCP Packet Data Convergence Protocol
RLC AM Radio Link Control Acknowledged Mode
DRB Data Radio Bearer
RS Reference Signal
SSB Signal Synchronization Block
CSI-RS Channel State Information Reference Signal
ARFCN Absolute Radio Frequency Channel Number
CLTM Conditional Layer 1/2 Triggered Mobility
SCS Sub-Carrier Spacing
PCI Physical Cell Identifier
RSSI Received Signal Strength Indicator
QCL Quasi Co-Located
BWP Bandwidth Part

The following documents and standards descriptions are hereby incorporated by reference into the present disclosure as if fully set forth herein:
[1] 3GPP, TS 38.300 v17.5.0, 5G; NR; NR and NG-RAN Overall Description; Stage 2.
[2] 3GPP, TS 38.331 v17.5.0, 5G; NR; Radio Resource Control (RRC) protocol specification.
[3] 3GPP, TS 38.321 v17.5.0, NR; Medium Access Control (MAC) protocol specification.

Mobility Management in Wireless Systems. 3GPP (Third-Generation Partnership Project) has developed technical specifications and standards to define the new 5G radio-access technology, known as 5G NR. Mobility handling is a critical aspect in any mobile communication system including 5G system. For a UE in connected mode, mobility is controlled by the network with the assistance from the UE to maintain an optimal connection quality. Based on the measured values of radio link quality of the serving cell and neighboring cell(s) reported by the UE, the network may hand over the UE to a neighboring cell that can provide better radio conditions when the UE is experiencing a degraded connection to the serving cell. The fundamental procedure of network-controlled mobility in connected mode is developed in Releasee 15 of 3GPP. Further, in release-16 NR, enhancements to network-controlled mobility in connected mode are introduced to mitigate connection interruption during handover procedure. Specifically, two enhanced handover mechanisms are developed, known as conditional handover (CHO) and dual active protocol stack (DAPS).

Generally. in a CHO procedure, upon receiving CHO configuration in a radio resource control (RRC) reconfiguration message which includes configurations for multiple candidate cells, a UE initiates evaluating the CHO execution conditions for the candidate cell(s). If at least one CHO candidate cell satisfies the corresponding CHO execution condition as described in more detail below, the UE detaches from the source cell, applies the configuration of the target cell, and synchronizes to the target cell, The UE thereupon completes the CHO procedure by sending an “RRC reconfiguration complete” message to the new target cell. The UE releases the stored CHO configurations after successful completion of the handover procedure.

More precisely, as described specified in 3GPP specifications in reference [1] identified above, a CHO is a handover that is executed by the UE when one or more handover execution conditions are met. The UE starts initiating the execution condition(s) upon receiving the CHO configuration and stops evaluating the execution condition(s) once a handover is executed. The following principles are applicable to a CHO. First, the CHO configuration of a candidate target cell includes the configuration of CHO candidate cell(s) generated by the candidate BS(s) and the execution conditions generated by the source BS. An execution condition may include one or two trigger condition(s) (such as CHO events A3/A5, as defined in in excerpt [2] above). Only single RS types are supported, and at most two different trigger quantities (e.g. Reference Signal Received Power (RSRP) and Reference Signal Received Quality (RSRQ), RSRP and Signal to Interference-plus-Noise ratio (SINR), etc.) can be configured simultaneously for evaluating the CHO execution condition of a single candidate cell.

Further, prior to any CHO execution condition is satisfied, upon reception of a HO command (that is, without a CHO configuration), the UE executes the HO procedure regardless of any previously received CHO configuration. Thus, unless and until the requisite CHO conditions are satisfied with reference to a candidate target BS, the HO procedure operates to supersede the CHO procedure. Finally while in the process of executing CHO, or more specifically from the time when the UE starts synchronization with target cell, UE does not monitor the source cell. These principles apply generally to CHOs in existing implementations.

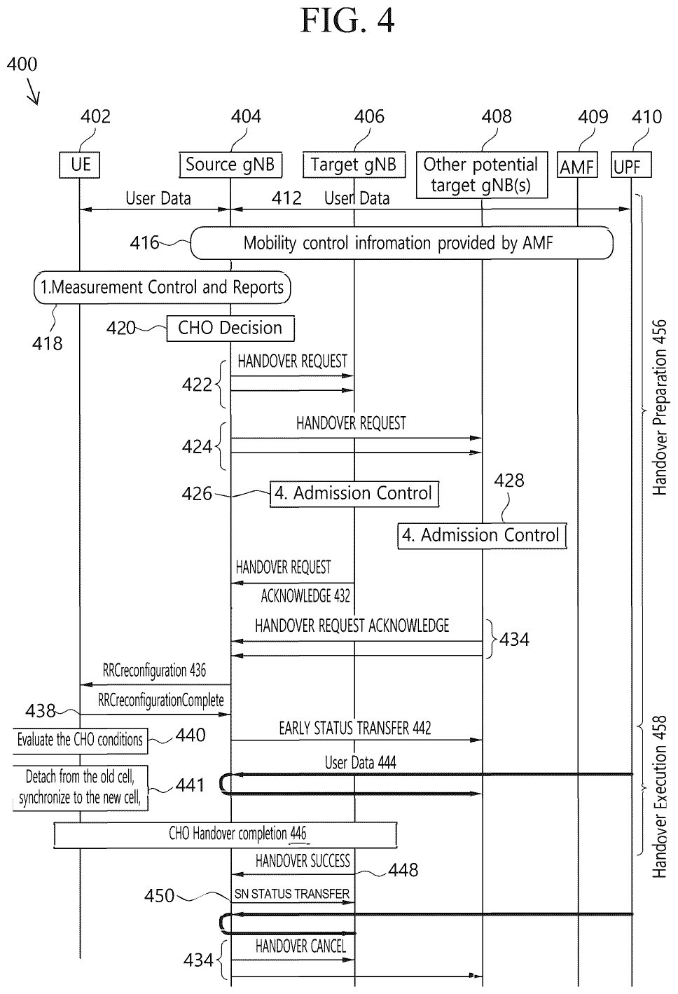

An intra-NR handover is an HO that is performed without the involvement of the 5GC network. As in intra-NR RAN handover, in an intra-NR RAN CHOs, the preparation and execution phases of the conditional handover procedure are likewise performed without involvement of the 5GC; i.e., preparation messages are directly exchanged between gNBs. The release of the resources at the source gNB during the CHO completion phase is triggered by the target gNB, rather than the 5GC network. FIG. 4 shows an example signaling diagram of a conditional handover procedure 400. It is noteworthy that in FIG. 4, the basic CHO set of operations is performed where neither the AMF nor the UPF changes. Shown in the top of FIG. 4 are the following devices or functions including UE 402, source gNB 404, target gNB 406, other potential target gNB(s) 408, the access mobility function (AMF) 409 and the user plane function(s) (UPF(s)) 410.

The UE context within the source gNB 404 includes information regarding roaming and access restrictions. This information was provided either at connection establishment or at the last tracking area update. As designated by 416, the UE context within the source gNB 404 includes information regarding roaming and access restrictions which were provided either at connection establishment or at the last tracking area update. During the handover preparation phase 456, the UE 402 exchanges user data with its source gNB 404, which data is provided to UPF(s) 410. This mobility control information was previously provided by the AMF 409. Referring to FIG. 4, at 418, the source gNB 404 configures the UE measurement procedures and transmits these procedures to the UE 402, and the UE 402 reports its measurements according to the provided measurement configuration. At 420, based on the measurement results received from the UE 402, the source gNB 404 determines that CHO should be used.

At 422, the source gNB 404 proceeds to transmit information requesting participation in a CHO to the target gNB 406. Similarly, at 424, the source gNB 404 sends a CHO request to one or more respective candidate target gNBs 408. The source gNB transmits a separate CHO request message is sent for each candidate cell. As shown in blocks 426 and 428, admission control procedures may be performed by the candidate target gNBs 406 and 408. Slice-aware admission control shall be performed if the slice information is sent from the source gNB 404 to the target gNB. Network slicing is a technique in which multiple virtual or customized networks are created on top of one shared physical network topology. Each slice can perform a different set of functions relating to a different transmission protocol. These different protocols may help ensure that each slice of the network has its own needed logical topology, together with security rules and performance characteristics specific to that slice. For example, one slice may use ultra-reliable low latency communication (URLLC), which requires high reliability and very low latencies. Other slice types may be directed to a high reliability and not so concerned with real-time communications. If the protocol data unit (PDU) sessions are associated with non-supported slices the target gNB shall reject such PDU Sessions.

Thereupon, at 432, the target gNB 406 sends a response (Handover REQUEST ACKNOWLEDGE) to the source gNB 404. At 434, each of the other candidate target gNBs 408 also sends an acknowledgement back to the source gNB 404. The responses sent to the gNB 406 includes the configuration of the CHO candidate cell(s). The CHO response message is sent for each candidate cell corresponding to gNBs 406 and 408. Having received the acknowledgements, the source gNB 404 sends an RRCReconfiguration message 436 to the UE, which message includes the configuration of CHO candidate cell(s) and CHO execution condition(s) (the latter being generated by the source gNB 404. It should be noted here that the CHO configuration of the candidate cells as discussed above may be followed by other reconfigurations received from the source gNB 404, such as when the circumstances change (e.g., the speed and trajectory of the UE are changed). It is also noted that a configuration of a CHO candidate cell cannot contain a dual access protocol stack (DAPS) handover configuration.

At 438, having received the information including the cell configuration and the configuration of the candidate target gNBs 408, the UE sends an RRCReconfigurationComplete message to the source gNB 404. The message 438 marks the end of the HO Preparation phase 456 and the beginning of the HO execution phase 458. In the event that early data forwarding is applied, the source gNB 404 sends the Early Status Transfer message to the potential target gNBs 408. During this time, the UE 402 maintains connection with the source gNB 404 after receiving CHO configuration, above. Prior to sending the RRCReconfigurationComplete message, the UE 402 starts evaluating the CHO execution conditions for the candidate cell(s) at 440. During this time, the source gNB may send an early status transfer message 442 to the other potential target gNBs. The user data 444 may be forwarded if necessary. Referring back to 440, if the corresponding CHO execution condition is met for at least one candidate target cell (say, the cell corresponding to target gNB 406), then at 441 the UE 402 detaches from the source gNB 404, applies the stored corresponding configuration for that selected candidate cell, synchronizes to that candidate cell and completes the RRC handover procedure by sending the RRCReconfigurationComplete message 438 (above) to the target gNB 406. At 446, the UE 402 further transmits a CHO completion message 446 to the source gNB 406 and remaining gNBs 408. The message releases stored CHO configurations after successful completion of RRC handover procedure. The transmission by the target gNB 406 of CHO completion message 446 marks the end of the HO execution phase 458 and signifies entry into the HO completion phase 460, below.

After the UE 402 has sent its HO complete messages at 446, if the target cell 406 has successfully acquired the UE, then at 450, the gNB 406 of the new target cell transmits at 448 a HANDOVER SUCCESS message to the source gNB 404. The gNB 404 at 450 sends the serving network (SN) STATUS TRANSFER message to the new gNB 406. It is noteworthy that as shown after the (SN) STATUS TRANSFER message at 450 in FIG. 4, late data forwarding may be initiated from UPF(s) 410 as soon as the source gNB 404 receives the HANDOVER SUCCESS message. At 434, the source gNB sends the HANDOVER CANCEL messages 454 toward the other gNBs that were not targeted in the CHO, which cancels the CHO for the UE 404.

For mobility management in connected mode, the handover is initiated by the network via higher layer signaling, e.g. RRC messaging based on L3 (Layer 3) measurements. Shortcomings are associated with this procedure. For one, this procedure involves increased latencies, higher signaling overhead, and more frequent interruption time that may become the key issue in some scenarios with frequent handover, such as, for example and without limitation, a UE in a high-speed vehicular and in an FR2 deployment. Consequently, reductions in overhead and/or latency and interruption time for the handover procedure become necessary. As such, a need arises for Layer 1/Layer 2 (L1/L2) Triggered Mobility (LTM), in which handovers can be triggered using L1/L2 signaling based on L1 physical layer measurements. More specifically, LTM refers to a mobility mechanism whereby the subject UE switches from the source cell to a target cell with beam-switching triggered by L1/L2 signaling, where the beam switching decision is based on L1 measurements on beams among neighboring cells.

Accordingly, as specified in 3GPP specification [1] identified above, LTM is a procedure in which a gNB (BS) receives L1 measurement report(s) from a UE, and based on the report(s), the BS changes UE's serving cell by a cell switch command signaled via a medium access control (MAC) control element (CE). The cell switch command indicates an LTM candidate cell configuration that the BS had previously prepared and provided to the UE through RRC signaling. The UE then switches to the target cell according to the cell switch command via the MAC-CE. The LTM procedure can be used to reduce the mobility latency.

In some configurations, the network may request the UE to perform early timing advance (TA) acquisition of a candidate cell prior to a cell switch. The early TA acquisition can be triggered by a PDCCH order or through UE-based TA measurement. The network indicates in the cell switch command whether the UE shall access the target cell using a random access (RA) procedure if a TA value is not provided or with a PUSCH transmission using the indicated TA value if the TA value is provided. For RACH-less LTM, the UE either monitors PDCCH for dynamic scheduling from the target cell assigned for the LTM cell switch, or the UE selects the configured grant occasion associated with the beam indicated in the cell switch command.

The following principles apply to LTM. First, the UE does not update its security key in LTM. Second, subsequent LTM HOs are supported. Third, LTM supports both intra-gNB-DU and intra-gNB-CU mobility, as well as inter-gNB-DU mobility. Third, LTM supports inter-frequency mobility, including mobility to an inter-frequency cell that is not a current serving cell.

LTM supports the following scenarios: PCell change in non-CA scenario, PCell change in CA scenario, dual connectivity scenario, at least for the PSCell change without MN involvement case, i.e. intra-SN PSCell change. A supervision timer can be used to detect failure of LTM cell switch procedure, wherein LTM procedure fails if the LTM supervision timer expires, upon which the UE initiates RRC connection re-establishment procedure.

While the UE has stored LTM candidate cell configurations, the UE can also execute any L3 handover command sent by the network. It is incumbent on the network to avoid any performance issue resulting from a collision between LTM execution and L3 handover execution. For example, the network is responsible for avoiding sending an LTM cell switch command and an L3 handover command simultaneously. Cell switch commands are conveyed in a MAC CE, which contains the necessary information to perform the LTM cell switch. Subsequent LTM is performed by repeating the early synchronization, LTM execution, and LTM completion steps without releasing other LTM candidate cell configurations after each LTM completion.

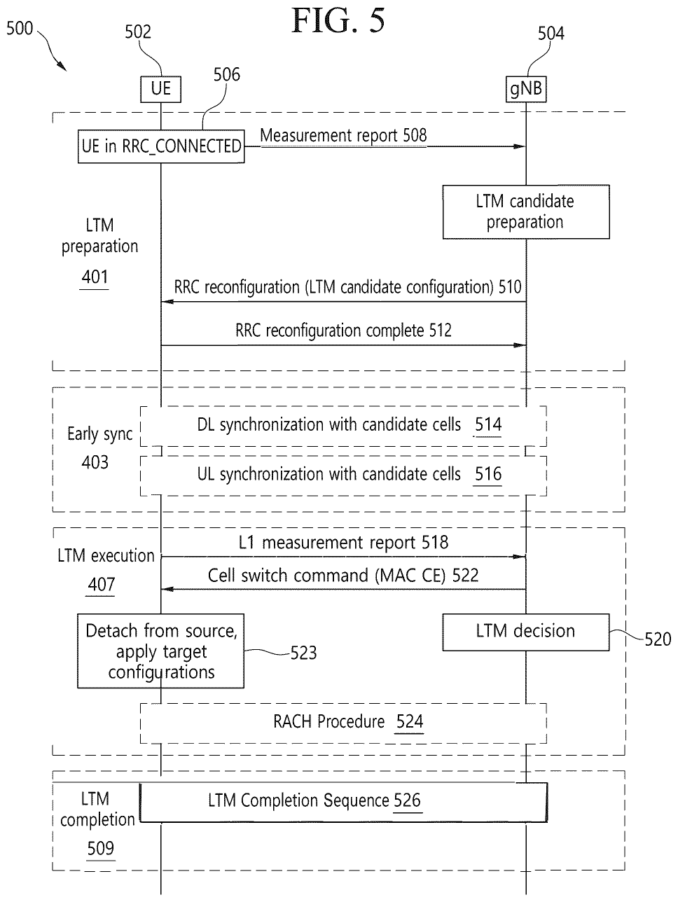

FIG. 5 shows an example signaling diagram of a procedure 500 for Layer 1/2 Triggered Mobility (LTM). A UE 502 and a serving gNB 504 are shown. At block 506, the UE 502 is in RRC_CONNECTED mode. At 508, UE 502 transmits a measurement report to the serving cell corresponding to gNB 504. The gNB/BS 504 decides to configure LTM and initiates candidate cell(s) preparation at the “LTM candidate preparation” block of the LTM preparation sequence 401. The gNB 504 transmits an RRC reconfiguration message at 510 to the UE 502, wherein the message to the UE includes the LTM candidate cell configurations of one or multiple candidate cells. The UE 502 stores the LTM candidate cell configuration(s) in a memory and thereafter transmits at 512 an RRCReconfigurationComplete message to the gNB 504.

Referring now to the early synchronization sequence 403, the UE 502 can perform at 514 downlink (DL) synchronization with one or more candidate cells before receiving the cell switch command. The UE can also perform at 516 early TA acquisition with candidate cell(s) requested by the network before receiving the cell switch command. These two operations 514 and 516 are performed via contention-free random access (CFRA) triggered by a PDCCH order from the source gNB 504, following which the UE sends a preamble towards the identified candidate cell. To minimize the data interruption of the source cell/gNB 504 due to CFRA towards the candidate cell(s), the UE 502 does not receive RAR for the purpose of TA value acquisition; the TA value of the candidate cell is instead indicated in the cell switch command. The UE 502 does not maintain the TA timer for the candidate cell and relies on the network implementation to guarantee the TA validity.

During the LTM execution sequence 407, UE 502 performs L1 measurements on the configured candidate cell(s) and transmits the L1 measurement reports at 518 to the BS 504. L1 measurements are performed if the RRC reconfiguration is ongoing in this sequence. The gNB 504 evaluates the UE measurements and decides to execute cell switch to a target cell via LTM. At 522, gNB 504 transmits a cell switch command 522 using a MAC CE. The cell switch is configured at the triggering cell by including the candidate configuration index of the target cell in the cell switch command 522. The MAC CE can also include TA information and a beam indication for the target cell. At 523 the UE 523 detaches from the source gNB 502, switches to the target cell, and applies the configuration indicated by candidate configuration index. The UE 502 next performs at 524 the random-access channel (RACH) procedure towards the target cell, if UE 502 does not have a valid TA of the target cell. Meanwhile, gNB 504 may make an LTM decision at 520.

Referring now to the LTM completion 509, UE 502 completes the LTM cell switch procedure by sending RRCReconfigurationComplete messages at 526 to the identified target cell. If the UE has performed an RA procedure at 524, the UE considers that LTM execution is successfully completed when the random access procedure is successfully completed. For RACH-less LTM in which the UE has the TA data, UE 502 considers that LTM execution to be successfully completed when the UE determines that the network has successfully received its first uplink (UL) data.

The steps in the early sync 403, LTM execution 407, and LTM completion 409 sequences can be performed multiple times for subsequent LTM cell switches using the LTM candidate cell configuration(s) provided from the current BS as in 510. Further, the listing of events in FIG. 5 does not imply a particular order of operation. In LTM, the UE 502 effectively performs a MAC reset. Whether the UE performs RLC re-establishment and packet data convergence protocol (PDCP) data recovery during cell switch is explicitly controlled by the network through RRC signaling. The PDCP data recovery procedure can be applied to the Radio Link Control Acknowledged Mode Data Radio Bearers (RLC AM DRBs) for an inter-DU LTM cell switch.

In one aspect of the present disclosure, the distinct advantages of CHO and LTM in both increasing HO reliability by triggering a handover with pre-configured conditions and in reducing HO latency by triggering the handover with L1/L2 signaling (rather than time-consuming upper layer communications and/or network control), it is proposed in this aspect to improve HO performance by combining components of LTM and CHO procedures to form a conditional low-layer (e.g. L1 and/or L2) in which, for instance, early TA acquisition and L1/L2 execution events based on L1 measurements evolve herein into a new HO mechanism. The procedure of a new HO mechanism as a combination of CHO and LTM is specified in the disclosure to follow. As an example, a sequence of events is disclosed below for forming a unique HO mechanism as a combination of CHO and LTM, referenced herein as conditional LTM (CLTM). In some embodiments, conditional LTM may refer to an LTM procedure in which execution condition(s) are evaluated for one or multiple candidate cells based on L1 measurements and in which the cell switch is executed only when requisite execution condition(s) are met.

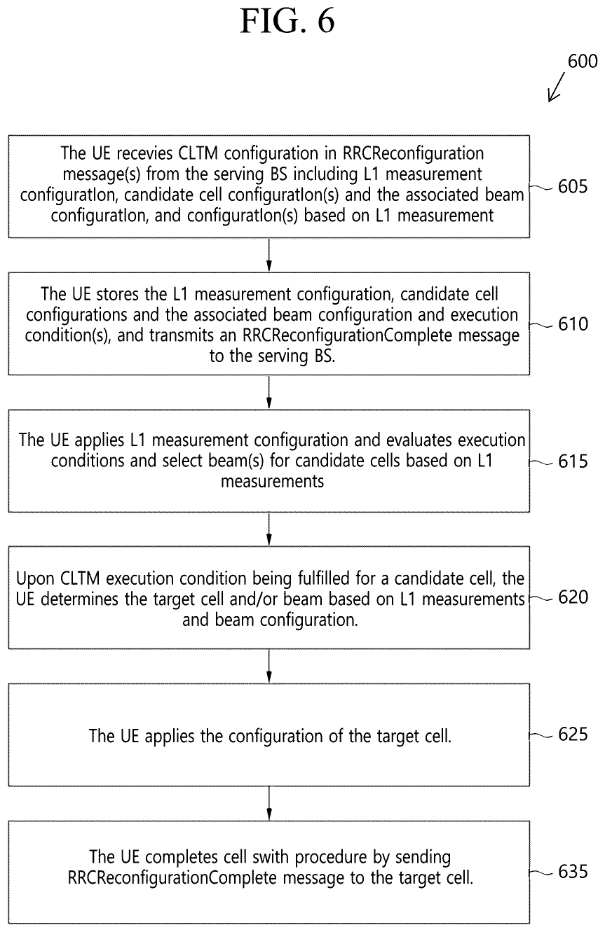

FIG. 6 shows an example flow diagram of a conditional LTM (CLTM) operation 600 of a UE in accordance with an embodiment. The steps described in FIG. 6 may be performed by a UE sending and receiving messages to or from a BS of a current serving cell and one or more BSs of candidate serving cells that may be present in nearby regions. Rather than the network initiating an HO when the simple criterion a received signal strength becoming too low, for example, the CLTM procedure may enable more complex conditions that are conducive to determining whether an HO for a particular network type or slice is suitable. As described below, the CLTM enables far more flexibility in determining the correct target cell. In addition to this distinct advantage, CLTM beneficially can increase the overall HO speed by having the UE effectuate the handover and thereby avoiding many of the latencies associated with internal network communications (for example, BS to BS communications the timing of which the subject UE has little or no control). In addition to overall handover speeds being increased using the principles herein, latencies can be significantly reduced for certain implementations, e.g., driverless vehicles and many other artificial intelligence and machine learning applications requiring ultra-low latencies or communications in or near real-time.

At block 605, the UE receives a CLTM configuration in RRCReconfiguration message(s) from the serving BS, which can include CLTM measurement configurations, candidate cell configuration(s) and the associated beam configuration and execution condition(s) that are based on L1 measurements. At block 610, the UE stores the L1 measurement configuration, candidate cell configurations and the associated beam configuration (which may be based on one or more metrics as described herein) and execution condition(s) in memory and transmits an RRCReconfigurationComplete message to the serving BS/cell. At block 615, the UE applies the L1 measurement configuration(s) and evaluates execution conditions and/or select beam(s) for candidate cells based on L1 measurements. For example, in one embodiment, if the execution condition and the L1 measurement configuration includes the RSRP (in decibels or dBs) of the candidate cells meeting or exceeding a first threshold and the RSRP of the serving cell falling below a second threshold, the UE evaluates these criteria by performing the L1 measurements for the serving cell and the candidate cell. Upon determining that the execution condition is met, the CLTM proceeds as described below. Where the execution condition is not met, the UE proceeds to evaluate other candidate cells in a similar manner, if such cells were identified in the one or more RRCReconfiguration messages from the BS.

At block 620, upon CLTM execution condition being met for a candidate cell, the UE determines a target cell and/or beam based on the L1 measurements and the beam configuration. Thereupon, at block 625, the UE applies the configuration of the target cell. At block 630, if the TA of the target cell is not acquired, the UE performs the Random Access (RA) procedure towards the target cell using the selected beam for transmission and/or reception. Otherwise, the UE skips the RA procedure and uses a scheduled uplink channel (e.g., PUSCH, etc.) if the TA is available at the UE. At block 635, the UE completes the cell switch procedure by sending RRCReconfigurationComplete message to the target cell using the selected beam.

For an embodiment in block 605, the CLTM L1 measurement configuration may include multiple components, which in turn can include one or more lists of measurement IDs, one or more list of measurement objects, one or more list of report configurations, and/or one or more list of quantity configurations. The measurement IDs, measurement objects, report configurations, or quantity configurations or some combination of these configurations are maintained by addition, modification, and/or release operations for the UE indicated in the provided configuration. Each measurement ID refers to a measurement object, a report configuration, or a quantity configuration, or a combination thereof, such that a measurement ID is associated with a measurement object ID, a report configuration ID, and/or a quantity configuration ID.

Elements of RS. Each measurement object can be defined as a CSI measurement resource for use in performing L1 measurements. A set of parameters defining a reference signal (RS) in the frequency domain, time domain, or spatial domain, or in some combination of these domains, is configured for a CSI measurement resource. Based on these parameters in the set, the reference signal (RS) can be identified in the frequency domain, time domain and/or spatial domain for use in CSI measurements. For example, the RS can be a signal synchronization block (SSB) and/or a channel state information reference signal (CSI-RS), either or both of which can be configured with a set or a subset of the following parameters. First, the set or subset may include an absolute radio frequency channel number (ARFCN) frequency value and/or a frequency band indicator to indicate the location in the frequency domain, or alternatively or additionally a Subcarrier Spacing (SCS) parameter. Second, the set or subset may include a list of Physical Cell IDs (PCI) to indicate the cells to which the RSs are associated to be measured or in some cases, not to be not measured, or both. Third, the set or subset may include a bitmap (e.g., short/medium/long SSB bitmap) and/or index(es) to indicate the SSB and/or CSI-RS indexes to be measured. Fourth, the set or subset may include a periodicity to indicate the periodicity of an SSB and/or a CSI-RS. Fifth, the set or subset may include an SSB Measurement Time Configuration (SMTC) to indicate the time window with one or more periodicity, duration, and offset parameters to measure the SSB. Sixth, the set or subset may include a RSSI Measurement Time Configuration (RMTC) to indicate the information in frequency and/or time and/or spatial domain (e.g., periodicity, duration, offset, frequency, BWP, SCS, TCI state) used for RSSI measurement. Seventh, the set or subset may include a frequency or time domain location, in some case additionally or alternatively including a time period of a CSI-RS to indicate the resource allocation. Eighth, the set or subset may include quasi-colocation (QCL) information to indicate the QCL relation between a SSB and a CSI-RS. Antenna ports are quasi-collocated if properties of one channel over which a data on a first antenna port is transmitted can be logically inferred from the channel over which data on a second, typically adjacent antenna port is conveyed. Ninth, the set or subset may include a measurement gap configuration (e.g., gap repetition period, gap length, gap type, gap offset, gap timing advance, etc.) to indicate the measurement gap used when measurement cannot be performed while simultaneously transmitting/receiving on the serving cell. Tenth, the set or subset may include an RS-specific offset value of the measurement quantity to indicate an offset value in a respective L1 measurement. Eleventh, the set or subset may include a cell-specific offset value of the measurement quantity to indicate an offset value in the respective L1 measurement. It should be noted that these elements are exemplary in nature and not restrictive, and any of these eleven elements, in some embodiments together with additional elements not specified herein, may be part of the set or subset of the CSI or RS.

Quantity configuration. Each quantity configuration specifies the measurement quantities and/or parameters to be used to filter, aggregate or otherwise consolidate L1 measurements as dictated by the algorithm. A quantity configuration configured for L1 measurements on SSB and/or CSI-RS may include one or more of the following parameters, which are exemplary in nature and not restrictive of the present disclosure. A first quantity configuration may include a measurement quantity (e.g., L1-RSRP, L1-RSRQ, L1-SINR, SS-RSRP, SS-RSRQ, SS-SINR, CSI-RSRP, CSI-RSRQ, CSI-SINR, etc.) to indicate the subject L1 measurement quantity. A second quantity configuration may include an RS-specific offset value of the measurement quantity to indicate an offset value associated with an L1 measurement. A third quantity configuration may include a cell-specific offset value of the measurement quantity to indicate an offset value in a corresponding L1 measurement. A fourth quantity configuration may include a threshold value above which the RS is considered for L1 measurement. A fifth quantity configuration may include a number of cells/RSs among all configured cells/RSs in a measurement object to be used for L1 measurement evaluation (e.g., to be averaged). A sixth quantity configuration may include filtering coefficients to indicate the coefficients to be used in the L1 measurement filtering. For example, coefficients/weights may be associated with an RS to be applied to average measurement results for a set of RSs. This list is not inclusive and other quantities may be used, alone or in combination with one or more of the six identified quantities above. For the measurement report configuration, each such configuration can include an indication of the report type. If the report type is identified, the type may be periodical, event triggered, or conditional. In embodiments involving a periodical and/or event-triggered report, and those involving conditional events to be evaluated without reporting, one or more of the following parameters may be configured. In some embodiments, an RS type may be configured to indicate the RS type to be reported and/or evaluated, which can be SSB and/or CSI-RS in some embodiments. A measurement quantity may be configured to indicate the quantity regardless of RS type to be reported/evaluated, which can be L1-RSRP, L1-RSRQ, L1-SINR, etc. The quantity may alternatively or additionally be configured to indicate the quantity together with the RS type be reported/evaluated, which can be L1-RSRP, L1-RSRQ, L1-SINR, SS-RSRP, SS-RSRQ, SS-SINR, CSI-RSRP, CSI-RSRQ, CSI-SINR, and other quantities not listed herein. The quantity may be further configured to include a report interval to indicate the time interval between reports. To this end, report periodicity and offset values may be configured in an embodiment to indicate when to perform or to or to send the report. The quantity may include an amount that indicates the number of measurement reports. For example, in an embodiment, a value larger than 1 indicates periodically event-triggered reporting. The quantity may be configured to include a maximum number of cells or RS indexes to be included in a measurement report. In some embodiments, the quantity may include a list of cell IDs (e.g., PCI, logical ID) to indicate the cell(s) for which the L1 measurement is reported. The quantity may alternatively or additionally include one or more offsets and thresholds associated with a corresponding measurement quantity to be used in one or more event conditions. In other embodiments, the quantity may include a “Time to trigger” (e.g., as specified by the Information Element (IE) timeToTrigger) to indicate the time during which specific criteria for the event needs to be met to trigger the subject event condition. Hysteresis, a magnetic-memory based phenomenon that may be pronounced in high frequency wireless systems that may affect measurement values, may be incorporated in the report configuration to indicate a parameter used for the entry and leaving condition of an event.

For a conditional trigger configuration in a report configuration, one or two conditional events may be configured for UE to evaluate execution condition associated with a candidate cell without reporting the measurement results. In other embodiments, more than two conditional events may be configured. For the purposes of this example, it is assumed that a maximum of two conditional events may be associated with a respective target cell.

Among all configured RSs (that is, the total number of RSs denoted by N) in a measurement object (e.g., CSI measurement resource) associated with a candidate cell or associated with the current serving cell, at least X out of the N RSs are measured or selected to evaluate a conditional event for the candidate cell (or for the current cell when performing a comparison, for example), where X is a configured integer value that can be 1, 2, . . . , N. For instance, UE can measure all N RSs, and use only X RSs to trigger the conditional event. Alternatively, the UE can select X RSs to measure and evaluate. It can be up to the specific UE implementation to measure the X RSs or to select X RSs among N RSs. Examples of conditional events are specified as follows. In an LTM-conditionalEvent-1, the best RS among the X RSs each associated with a candidate cell becomes at least an amount of offset better than the best RS among X RSs associated with the current serving cell (e.g., PCell, PSCell, SCell, and the like). The best RS refers to the RS for which the measurement result in terms of the configured measurement quantity has the best value (which may be the highest value in terms of a signal quality, signal power, or signal-to-noise ratio measurement event, or which may in some cases be the lowest value (e.g., when measuring latencies). As noted above, the offset may be a value that is configured for this measurement quantity. In an LTM-conditionalEvent-2, the average of the X RSs associated with a candidate cell becomes at least an amount of offset better than the average of the X RSs associated with the current serving cell (e.g., PCell, PSCell, SCell, etc.). The average of the X RSs refers to the averaged measurement result in terms of the configured measurement quantity among the X RSs. The offset, as in the case above, is a configured value in terms of this measurement quantity. In one embodiment, the linear average is applied to determine the average measurement result. In another embodiment, the weighted average is applied to determine the average measurement result, where a weight is multiplied to the actual measured value of a RS and the weight parameter for each RS is configured. In still another embodiment, the averaging function is left to the UE implementation.

In some embodiments, an LTM-conditionalEvent-3 may be used. Each of the X RSs associated with a candidate cell becomes at least amount of offset better than each of the X RSs associated with the current serving cell (e.g., PCell, PSCell, SCell, etc.). The comparison between an RS associated with the candidate cell and an RS associated with the current serving cell (e.g., PCell, PSCell, SCell) is in terms of the configured measurement quantity, and the offset is a configured value in terms of this same measurement quantity. For example, the correspondence or mapping between an RS of a candidate cell and an RS of the current serving cell is considered. The correspondence or mapping may be configured, e.g., RS Index A of a candidate cell is compared with RS Index B of the serving cell. Alternatively, the correspondence or mapping is implicit in that RS Index A of a candidate cell, for instance, is compared with the RS of the same Index value of the serving cell, e.g., SSB #1 of a candidate cell is compared with SSB #1 of the serving cell. In another embodiment, the correspondence or mapping between an RS of a candidate cell and a RS of the current serving cell is not restricted to allow flexible measurement and evaluation.

For LTM-conditionalEvent-1/2/3 described above, an entering condition and a leaving condition for a target cell and the current serving cell, respectively, may be described. In an embodiment, an entering condition is deemed fulfilled for this event to be satisfied when condition A-1, as specified below, is fulfilled. Similarly, the leaving condition for this event to be satisfied when condition A-2, as specified below, is fulfilled;

$$Inequality A - 1 ( Entering condition ) : Mn + Ofn + Ocn - Hys > Mp + Ofp + Ocp + Off$$

$$Inequality A - 2 ( Leaving condition ) : Mn + Ofn + Ocn + Hys < Mp + Ofp + Ocp + Off$$

Thus, an entering condition (Inequality A-1) to switch to a target cell may include a situation where a first combination of variables exceeds a combination of variables, where the combination may be achieved via addition or subtraction. Similarly, a leaving condition (Inequality A2) to leave a source or current serving cell may include a situation where a sum of the same variables on the left-hand side of the inequality A-1 is less than another sum of the same variables on the right-hand side of A1. In the exemplary inequalities A1 and A2 described above, Mn is the measurement result (i.e., measurement quantity value) of the candidate cell, not considering any offsets. Ofn is the measurement object specific offset of the RS of the candidate target cell (such as configured in the measurement object or in the quantity configuration associated with the candidate cell). Ocn is the cell specific offset of the candidate cell (such as configured in the measurement object or in the quantity configuration associated with the candidate cell). Ocn may simply be set to zero if not configured for the candidate target cell. Mp is the measurement result of the serving cell (e.g., PCell, PSCell, SCell), not considering any offsets. Ofp is the measurement object specific to the RS of the serving cell (e.g., as configured in the measurement object or in the quantity configuration associated with the serving cell). Ocp is the cell specific offset of the serving cell (e.g., as configured in the measurement object or in the quantity configuration associated with the serving cell). Like with Ocn to the target cell, Ocp may be set to zero if not configured for the serving cell. Hys is the hysteresis parameter for this event (i.e. as configured in the report configuration associated to this event). Off is the offset parameter for this event (i.e. as configured in the report configuration associated to this event). Mn and Mp are expressed in decibel-milliwatts (dBm) in the case of metric RSRP, which is a unit used to indicate that a power level as expressed in decibels with respect to one milliwatt (mW) or in decibels (dB) in the case of metrics RSRQ and RS-SINR. Ofn, Ocn, Ofp, Ocp, Hys, and Off are expressed in dB, although different measurement units may be used depending on the application.

Referring now to example execution condition LTM-conditionalEvent-4, the best RS among the X RSs associated with a candidate cell becomes better than a threshold. The best RS refers to the RS for which the measurement result in terms of the configured measurement quantity has the best value, and the threshold is a configured value in terms of this measurement quantity. For LTM-conditionalEvent-5, the average of the X RSs associated with a candidate cell becomes better than a threshold. The average of the X RSs refers to the averaged measurement result in terms of the configured measurement quantity among the X RSs. The threshold is a configured value in terms of this measurement quantity. In one embodiment, the linear average is applied to determine the average measurement result. In another example, the weighted average is applied to determine the average measurement result. In this latter scenario, a weight is multiplied by the actual measured value of an RS and the weight parameter for each RS is configured accordingly. In still another embodiment, the averaging function may be left to the discretion of the UE implementation. For LTM-conditionalEvent-6, each of the X RSs associated with a candidate cell becomes better than a threshold. In this embodiment, the comparison between an RS associated with the candidate cell and the threshold is in terms of the configured measurement quantity. The threshold is a configured value in terms of this measurement quantity. In short, for LTM-conditionalEvent-4/5/6, the entering condition for this event is deemed to be satisfied when condition B-1, as specified below, is fulfilled. Similarly, the leaving condition for this event is deemed to be satisfied when condition B-2, as specified below, is fulfilled;

$$Inequality B - 1 ( Entering condition ) : Mn + Ofn + Ocn - Hys > threshold .$$

$$Inequality B - 2 ( Leaving condition ) : Mn + Ofn + Ocn + Hys < threshold .$$

This embodiment differs from the prior embodiment in that the comparison is performed only relative to a threshold. Thus, the measurement parameters relating to the serving cell (e.g., Mp) need not be taken into account. Mn is the measurement result (e.g., the measurement quantity value) of the candidate cell, not considering any offsets. Ofn is the measurement object specific offset of the RS of the candidate cell (such as configured in the measurement object or in the quantity configuration associated with the candidate cell). Ocn is the cell specific offset of the candidate cell (i.e. as configured in the measurement object or in the quantity configuration associated with the candidate cell). As in embodiments above, Ocn may be set to zero if not configured for the candidate cell. Hys is the hysteresis parameter for this event (e.g., as configured in the report configuration associated to this event). The term threshold is the threshold parameter for this event (e.g., as configured in the report configuration associated to this event). As in the embodiments above, Mn is expressed in dBm in case of RSRP, or in dB in case of RSRQ and RS-SINR. Ofn, Ocn, Hys are expressed in dB. threshold is expressed in the same unit as Mn. As before other equivalent units of measurement may be used to produce the same result, without departing from the principles of the present disclosure.

LTM-conditionalEvent-7 is an embodiment analogous to Event 3, above. That is, the best RS among the X RSs associated with a candidate cell becomes greater than a first threshold (called threshold1), and the best RS among X RSs associated with the current serving cell (e.g., PCell, PSCell, SCell, etc.) becomes worse than a second threshold (threshold2). Like in the other examples, the best RS may refer to the RS for which the measurement result in terms of the configured measurement quantity has the best value, and threshold1, threshold2 are configured values in terms of this measurement quantity. Likewise, for LTM-conditionalEvent-8, the average of the X RSs associated with a candidate cell becomes better than a threshold1, and the average of the X RSs associated with the current serving cell (e.g., PCell, PSCell, SCell, etc.) becomes worse than a threshold2. Like the embodiment above, the average of the X RSs refers to the averaged measurement result in terms of the configured measurement quantity among the X RSs. Further, the values threshold1, threshold2 in this example are configured values in terms of this measurement quantity. In one example, the linear average is applied to determine the average measurement result. In another example, the weighted average is applied to determine the average measurement result, wherein a weight is multiplied by the actual measured value of an RS and the weight parameter for each RS is configured. In yet another embodiment like those above, the averaging function is left to the discretion of the UE implementation. In still another embodiment using LTM-conditionalEvent-9, each of the X RSs associated with a candidate cell becomes better than a first threshold, while each of the X RSs associated with the current serving cell (e.g., PCell, PSCell, SCell, etc.) becomes worse than a second threshold. The comparison between a RS associated with the candidate cell and the first threshold, together with the comparison between a RS associated with the current serving cell (e.g., PCell, PSCell, SCell) and the second threshold are made in terms of the configured measurement quantity. The first and second thresholds are configured values in terms of this measurement quantity. In an example, the correspondence or mapping between an RS of a candidate cell and an RS of the current serving cell is considered. The correspondence or mapping can be configured in the same order or in different orders (e.g., for the different orders, RS Index A of a candidate cell may be compared with RS Index B of the serving cell). Alternatively, the correspondence or mapping may be made implicit such that RS Index A of a candidate cell is compared with the RS of the same Index value of the serving cell. Thus, in this embodiment, SSB #1 of a candidate cell is compared with SSB #1 of the serving cell. In another embodiment, the correspondence or mapping between a RS of a candidate cell and a RS of the current serving cell is not restricted to allow flexible measurement and evaluation. In short, in embodiments using LTM-conditionalEvents-7/8/9, the entering condition for this measurement event is considered satisfied when both condition C-1 and condition C-2, as specified below, are fulfilled. However, unlike the entering condition which in this example requires both conditions to be fulfilled, the leaving condition for this measurement event is satisfied when either condition C-3 or condition C-4, or at least one of the two, as specified below, is fulfilled;

$$Inequality C - 1 ( Entering condition 1 ) : Mp + Hys < threshold 1.$$

$$Inequality C - 2 ( Entering condition 2 ) : Mn + Ofn + Ocn - Hys > threshold 2.$$

$$Inequality C - 3 ( Leaving condition 1 ) : Mp - Hys > threshold 1.$$

$$Inequality C - 4 ( Leaving condition 2 ) : Mn + Ofn + Ocn + Hys < threshold 2.$$

The variables in the inequalities are like those above and for completeness are characterized as follows: Mp remains the measurement result of the serving cell (e.g., PCell, PSCell, SCell), not taking into account any offsets. Mn remains the measurement result (that is, the measurement quantity value) of the candidate cell, not taking any offsets into account. Ofn is the measurement object specific offset of the RS of the candidate cell (such as configured in the measurement object or in the quantity configuration associated with the candidate cell). Ocn is the cell specific offset of the candidate cell (such as configured in the measurement object or in the quantity configuration associated with the candidate cell). Ocn is set to zero if not configured for the candidate cell. Hys is the hysteresis parameter for this event (such as configured in the report configuration associated to this event). The first and second thresholds (e.g., threshold 1 and threshold 2) are the threshold parameters for this event (again, as configured in the report configuration associated to this event). Mn and Mp are, as before, expressed in dBm in case of RSRP, or in dB in case of RSRQ and RS-SINR. Ofn, Ocn, Hys are expressed in dB. The value threshold1 is expressed in the same unit as Mp. The value threshold2 is expressed in the same unit as Mn.

Referring to FIG. 6, an example embodiment of block 605 is presented. A list of candidate cells for CLTM can be configured. Each candidate cell is identified by a candidate cell ID, and provided with a configuration (e.g., an RRCReconfiguration message) to be applied at CLTM execution. Each cell in the list is pre-configured with a beam configuration (e.g., TCI state configuration), and associated with at least one execution condition. The beam configuration can include a list of TCI states. For each TCI state, a TCI state ID or QCL information can be associated with the channel. This information may include a QCL type and an RS identity, where the RS can be defined by a physical cell identifier (PCI), a bandwidth part (BWP) ID, an RS type (e.g., SSB, CSI-RS) and an RS index, or some combination thereof. The set of TCI states of a candidate cell are maintained, added, updated, deleted or otherwise modified in the UE memory.

The execution condition can be indicated by one or two triggering events, or in some embodiments, more than two triggering events. For purposes of simplicity, one or two triggering events are considered in these examples. Each triggering event can be indicated by a measurement ID that refers to a measurement object (e.g., a CSI measurement resource) and the associated report configuration (e.g., a conditional event) in the CLTM L1 measurement configuration. The execution condition associated with a candidate cell need to be met to trigger the execution of the conditional reconfiguration for CLTM. When configuring two triggering events (e.g., measurement IDs) for a candidate cell, both events can refer to the same measurement object (e.g., CSI measurement resource).

With reference now to block 610 of FIG. 6, the UE may maintain a variable Var-1 to store the candidate cell configuration and the associated beam configuration and execution condition. For each entry received in the list of candidate cells, if Var-1 includes an entry with the given candidate ID, and if the entry includes an execution condition, the UE may be configured to replace the existing execution condition within Var-1 with the received execution condition for this candidate ID. Similarly, if Var-1 includes an entry with the given candidate ID, and if the entry includes a RRCReconfiguration message, the UE may replace the existing RRCReconfiguration message within Var-1 with the newly received RRCReconfiguration message for this candidate ID. Assuming Var-1 includes an entry with the given candidate ID, and if the entry includes a beam configuration, the UE may be configured to replace the existing beam configuration within Var-1 with the received beam configuration for the given candidate ID. In other embodiments, if Var-1 does not include an entry with the given candidate ID, the UE is configured to add a new entry for this candidate ID within Var-1.

As an embodiment of block 610, the UE may maintain a variable Var-2 to store the L1measurement configuration. To maintain the measurement IDs, for measurement ID included in the removal list of measurement IDs in the L1 measurement configuration stored in Var-2, the UE may be configured to remove the entry with the matching measurement ID from the measurement ID list within the Var-2. The UE may also remove the measurement reporting entry for this measurement ID from the measurement reporting list, if included. The UE may terminate any timer relevant to the measurement that one is running and reset the associated information (e.g. timeToTrigger) for this measurement ID. Further, for each measurement ID included in the AddMod list of measurement IDs in the L1 measurement configuration, if the measurement ID is already included in the measurement ID list in Var-2, the UE may replace the entry with the value received for this measurement ID. Otherwise, if there is no existing entry for this measurement ID, the UE may proceed to add a new entry for this measurement ID within the Var-2. For existing measurement IDs in the AddMod list, the UE may remove the measurement reporting entry for this measurement ID from the measurement reporting list, stop the any relevant timer then running, and reset the associated information (e.g. timeToTrigger) for this measurement ID. If the measurement ID referring to a conditional event is modified, the executions conditions are considered to be not met, at least until the conditions are met with the modified measurement ID and associated information.

To maintain the measurement objects, for each measurement object ID received that is also in the removal list of measurement objects in the L1 measurement configuration contained in Var-2, the UE is configured to remove the entry with the matching measurement object ID from the measurement object list within the Var-2. The UE may also remove any measurement ID associated with this measurement object ID from the measurement ID list within the Var-2. Further, the UE may remove the measurement reporting entry for this measurement ID from the measurement reporting list, if included. Like before, the UE terminates any relevant timer running for this measurement object ID, and reset the associated information (e.g. timeToTrigger) for this measurement object ID. For each received measurement object ID that is included in the AddMod list of measurement objects in the L1 measurement configuration, and if the measurement object ID is contained in the measurement object list in Var-2, the UE then reconfigures the entry with the value received for this measurement object. Otherwise, if the there is no such measurement ID in the AddMod list, the UE adds a new entry for this measurement object within the Var-2. For each measurement ID associated with this measurement object ID from the measurement ID list within the Var-2 (if any), the UE may remove the measurement reporting entry for this measurement ID from the measurement reporting list, if included, stop the any relevant timer that is running for this measurement ID, and reset the associated information (e.g. timeToTrigger) for this measurement ID.

To maintain the report configuration, for each report configuration ID received and included in the removal list of the report configurations in the L1 measurement configuration contained in Var-2, the UE is configured to remove the entry with the matching report configuration ID from the report configuration list within the Var-2. Here again, the UE may remove all measurement ID associated with this report configuration ID from the measurement ID list within the Var-2 (if any) and may remove the measurement reporting entry for this measurement ID from the measurement reporting list, if included. The UE stops any running timer for this report configuration ID and resets the associated information (e.g. timeToTrigger) for use with the received measurement ID. For each received report configuration ID also included in the AddMod list of report configurations in the L1 measurement configuration, if the report configuration ID is included in the report configuration list in Var-2, the UE may reconfigure the entry with the value received for this report configuration. For each measurement ID associated with this report configuration ID from the measurement ID list included within the Var-2, the UE removes the measurement reporting entry for this measurement ID from the measurement reporting list, stops any running timer relevant to this measurement ID, and resets the associated information (e.g. timeToTrigger) for this measurement ID. If the report configuration ID is not contained in the report configuration list in Var-2, the UE is configured to add a new entry for this report configuration within the Var-2.

With continued reference to FIG. 6, as an embodiment of block 615, for each candidate ID stored in the pertinent UE variable, the UE may evaluate the associated execution condition according to the L1 measurement configuration. If the RRCReconfiguration within the candidate cell configuration includes the masterCellGroup including LTM cell switch information, the UE may consider the cell having a physical cell identity matching the value indicated in the ServingCellConfigCommon included in the LTM cell switch information within the masterCellGroup in the received candidate cell configuration to be applicable cell. Otherwise, if no such physical cell identity is present in the masterCellGroup and if the RRCReconfiguration within the candidate cell configuration includes the secondaryCellGroup including LTM cell switch information, the UE may consider the cell with a physical cell identity matching the value indicated in the ServingCellConfigCommon included in the LTM cell switch information within the secondaryCellGroup within the received candidate cell configuration to be the applicable cell for purposes of the CLTM. As an example, the evaluation of the execution conditions of each applicable cell is performed at the physical layer (L1).

As a further embodiment of block 615, when evaluating the execution condition for a candidate cell associated with a candidate ID, the UE may refer to each measurement ID included in the measurement ID list within Var-2. For each measurement ID indicated in the execution condition associated with the candidate ID, and for the conditional event associated with this measurement ID, the UE may consider that the conditional event associated with this measurement ID is met if the entry condition(s) of this event is fulfilled for the associated candidate cell during the corresponding timeToTrigger defined for this event. Similarly, if the leaving condition(s) of this event is fulfilled for the associated candidate cell during the corresponding timeToTrigger defined for this event, the UE may consider that the event associated with this measurement ID is not fulfilled. If event(s) associated to all measurement ID(s) of the execution condition for a candidate cell are fulfilled, the UE proceeds to consider the candidate cell associated with that candidate ID to be the new serving cell.

As still another embodiment of block 615, when evaluating the execution condition for a candidate cell associated with a candidate ID, for a conditional event in the execution condition, a time duration can be configured for the evaluation. The time duration can be specific to a conditional event, specific to an execution condition and/or specific to a candidate cell. For example, upon initiating an evaluation of a conditional event for a candidate cell, if a time duration is configured for the event or for the candidate cell, the UE may start a timer and set the timer duration as the value indicated by the time duration parameter. While the timer is running, the UE evaluates the conditional event(s) by measuring the RSs configured in the associated measurement object (e.g., CSI resource) for the candidate cell. While the timer is running, if the candidate cell becomes a triggered cell, the UE stops the timer. Otherwise, upon expiration of the timer, the UE stops evaluating the conditional event(s) for the candidate cell. As an example, the UE may release the CLTM configuration (e.g., RRCReconfiguration message, beam configuration, execution condition) stored in the UE variable(s) associated with the candidate cell upon the expiration of the timer, provided the timer is configured specific to the candidate cell.

As still another embodiment of block 615 and block 620, to determine the target cell, if there is only one triggered cell, (namely, the cell for which the execution condition is met), the UE considers the triggered cell as the selected target cell for CLTM execution. If more than one triggered cell exists, UE selects one of the triggered cells as the target cell for CLTM execution. For the target cell of CLTM execution, UE applies the stored configuration (e.g., a corresponding RRCReconfiguration message) of the target cell and performs the actions for RRC reconfiguration as further specified in [2], cited above. In one example, a UE-specific implementation may be used to select a triggered cell as the target cell when there are multiple triggered cells, e.g. the UE considers L1 measurement results of the RS(s) in the measurement object. The UE may, for example, consider the information (e.g., CSI measurement resource) associated with the measurement ID in the execution condition in making this determination of the new serving cell. In another example, when there are multiple triggered cells, if a same conditional event (e.g., the LIM-conditionalEvent field) is evaluated for different triggered cells, UE may select the cell with the best L1 measurement result as the target cell, wherein the L1 measurement result refers to the measurement result (e.g., measurement quantity) used to evaluate the conditional event associated with the measurement ID in the execution condition. If different conditional events are evaluated for different triggered cells, a UE-specific implementation may determine which triggered cell to select as the target cell. In another example, when there are multiple triggered cells, if there is only one triggered cell for which the Timing Advance (TA) is acquired and valid, UE selects that cell as the target cell. If there exists more than one triggered cell for which the TA is acquired and valid, UE selects the cell for which the TA has longest validity duration from the current time. As an example, the UE determines the target cell at L1 based on L1 measurement results and thereafter conveys this information as appropriate to upper layers (e.g., MAC, RLC, PDCP, RRC).

As another embodiment of block 615 and/or 620, the UE can select the beam(s) to be used for CLTM execution. Here, a beam can refer to a TCI state, and beam selection can include the selection of a joint/DL TCI state and/or a UL TCI state. The beam selection may be performed when evaluating the execution condition of a candidate/applicable cell (block 615) prior to determining a target cell as the new serving cell. If the candidate/applicable cell becomes a triggered cell and is selected as the new serving cell, the selected beam(s) are applied for reception and/or transmission when performing a cell switch to the target cell. Alternatively, the beam selection can be performed once the target cell/new serving cell is determined (i.e., block 620), and the selected beam(s) are applied for reception and/or transmission when performing cell switch to the target cell. As an example, the beam may be selected at L1 based on L1 measurement results and thereafter conveyed to upper layers (e.g., MAC, RLC, PDCP, RRC).

To determine the beam(s) to be applied for a cell (e.g., candidate cell, applicable cell, triggered cell, target cell. etc.), the UE may be configured to select beam(s) based on the L1 measurement results resulting from the execution condition evaluation. For instance, the UE can select beam(s) quasi-collocated with one of the measured RSs that is associated with the conditional event and which is fulfilled when evaluating the execution condition of the cell. The UE can first select an RS, and then determine beam(s) associated with the selected RS. In one embodiment, the UE implementation may dictate which measured RS is selected among all measured RSs associated with the fulfilled conditional event. In another case, the UE can select the best RS among the X RSs used in evaluating event condition(s), wherein the best RS refers to the RS for which the measurement result in terms of the evaluated measurement quantity has the best value. If there is only one beam associated with the selected RS according to the beam configuration (e.g., TCI state configuration) of the target cell, UE selects that beam. If there are multiple beams associated with the selected RS according to the beam configuration (e.g., TCI state configuration) of the cell, the UE-specific implementation may dictate how to select one beam. Alternatively, the UE may simply select the beam that is used and that provides the best L1 measurement result (e.g., measurement quantity value) when measuring the selected RS.

As an embodiment of block 625, UE applies the stored RRCReconfiguration message (e.g., stored in Var-1) associated with the candidate ID of the target cell, and performs the procedure of RRC reconfiguration as specified in reference [2], cited above.

As an embodiment of block 630, if the TA of the target cell is not acquired, the UE performs the Random Access (RA) procedure towards the target cell. As before, the UE can select an SSB or a CSI-RS based on the selected joint/DL TCI state. The UE may then send a Msg1 in PRACH at the PRACH occasion(s) associated with the selected SSB/CSI-RS. If two-step RA is performed, UE can send another message (MsgA) using the selected PRACH occasion and the associated PUSCH resource of MsgA. For instance, the UE can use the selected joint TCI state or UL TCI state to send the Msg1/MsgA. For an embodiment of block 635, the UE can send RRCReconfigurationComplete message to the target cell using the selected joint TCI state or UL TCI state.

While this disclosure focuses predominantly on solutions for conditional lower layer limited triggered mobility management including handovers, the solutions may also be implemented in X-MIMO systems, for example. However, any of these technologies disclosed herein may be extended to other applications and need not be limited to 3GPP. Examples include implementing these technologies in products embodying the family of IEEE 802.11 wireless communication protocols, in which mobility management may also be employed. Further, as 6G standards continue to evolve, the techniques herein may be optimal to overcome many of the challenges and constraints that are discussed above, including solving new problems as 6G continues its evolution. In addition, the principles of the disclosure may be equally applicable to implementations in LTE (4G), LTE-A, 5G, 5G-A, and other presently unknown further specifications and products embodying those specifications.

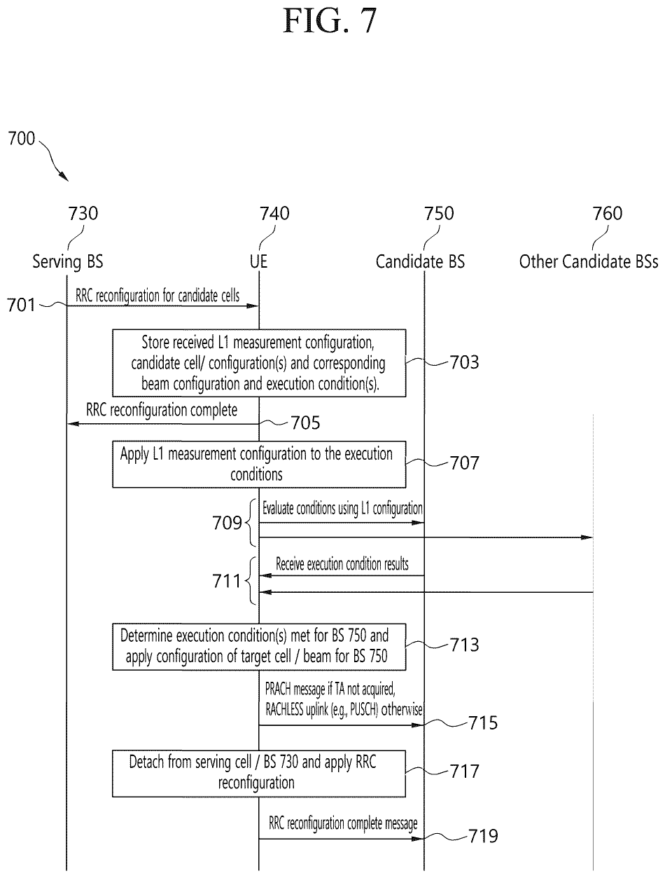

FIG. 7 shows an example signaling diagram of a conditional LTM (CLTM) operation 700 of a UE in accordance with an embodiment. Here, UE 740 is currently interacting with its serving BS 730. A candidate BS 750 as well as other candidate BSs are labeled and become relevant to the CLTM operation that is demonstrated in this embodiment.

Beginning at 701, the serving BS 730 sends an RRC reconfiguration for candidate cells to the UE 740. The RRC reconfiguration information includes an L1 measurement configuration, one or more candidate cell configurations, beam configurations corresponding to the one or more candidate cell configurations, and execution conditions for each of the one or more candidate cell configurations. At block 703, the UE 740 stores the received L1 measurement configuration, the candidate cell configurations, the corresponding beam configurations and the execution conditions, with at least one execution condition per candidate cell. Thereupon, at 705, the UE sends a confirming RRC reconfiguration complete message back to the serving BS 730. Thereafter, at 707, the UE 740 proceeds to apply the L1 measurement configuration to the execution conditions as described in detail above. In this embodiment UE 740 sends transmissions at 709 for evaluating the execution conditions using the L1 configuration to the candidate BS 750 as well as the other candidate BSs 760. At 711, the UE 740 receives the requested L1 measurement results from both the candidate BS 750 and the remaining candidate BSs 760. At block 713, the UE determines that the execution conditions(s) are met within the allotted time for BS 750, but not for any of the other candidate BSs 760. Accordingly, at block 713, the UE 740 determines that the execution conditions are met for BS 750 and applies the configuration of the now target BS 750 as well as the beam configuration obtained from an L1 measurement. Following the newly applied configuration, the UE adjusts its lists in memory accordingly and transmits a message over the physical random access channel (PRACH) if a TA has not been acquired. Conversely, if the TA was acquired during the CLTM or was otherwise in the possession of UE 740, the UE at 715 instead sends a RACHLESS uplink message (for example, over the PUSCH). At block 717, the UE 740 detaches from the serving BS 730 and applies the RRC reconfiguration corresponding to the new serving cell (BS 750).

The UE 740 concludes the CLTM by sending an RRC reconfiguration complete message to the new serving cell (BS 750).

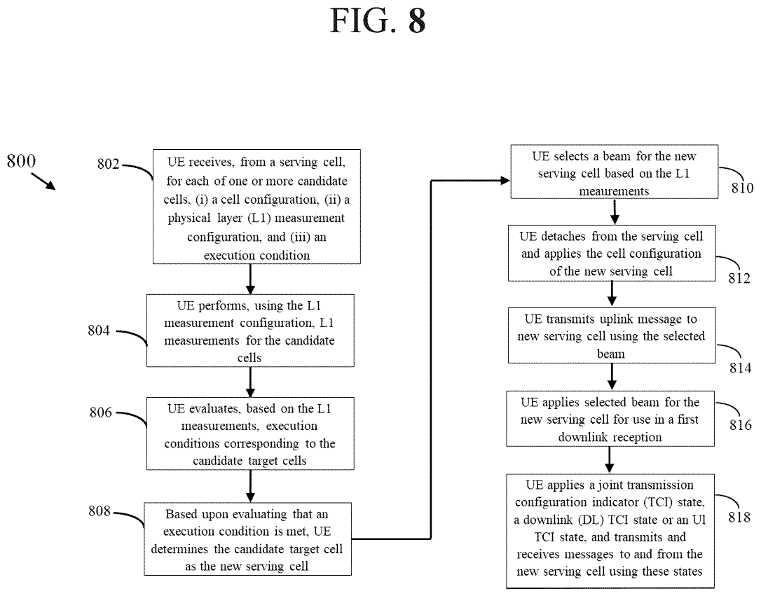

FIG. 8 shows an example flow diagram of a CLTM operation of a UE 800 in accordance with an embodiment. The method as disclosed in FIG. 8 may be performed by a UE, such as any of the UEs disclosed in FIG. 1, for example. At block 802, the UE receives from its serving cell for each of one or more candidate cells (1) a cell configuration, (ii) a physical layer (L1) measurement configuration or depending on the implementation, more than one, and (iii) an execution condition. It was noted that for each candidate cell under consideration there may be more than one execution condition as well, Thus the UE has, for each of the candidate cells, the configuration of that cell, a physical layer measurement configuration(s), and at least one execution condition. Referring to block 804, the UE performs, using the provided L1 measurement configuration, L1 measurements for each of the candidate cells identified in block 802. Thereupon, at block 806, the UE proceeds to evaluate, based on the L1 measurements taken in block 804, execution condition(s) corresponding to each candidate target cell. If two execution conditions are associated with a candidate cell, then generally both conditions must be met to induce a CHO for that target cell; otherwise, if one of the two execution conditions in that situation are not met, there will be no CHO for that particular cell. In other cases, there may be simply one execution condition per candidate cell. At block 808, based upon evaluating that an execution condition(s) is met for a candidate target cell, the UE determines the candidate target cell to be the new serving cell.

Thereupon, at block 810, the UE also selects a beam for the new serving cell based on the L1 measurements performed in block 804, above. At 812, the UE proceeds with the CLTM, detaching from the old serving cell and applying the cell configuration of the new serving cell. At block 814, the UE transmits an uplink message to the new serving cell using the selected beam. As discussed in greater detail above, this message may be applied using random-access or RACHless techniques, depending on whether the UE has acquired the timing advance for the new serving cell. In some cases, the UE may send the new serving cell a (UEReconfigurationComplete message to identify that the CLTM procedure has completed. At block 816, the UE applies the selected beam for the new serving cell for use in a first downlink transmission from the new serving cell. In addition, at block 818, the UE applies a joint transmission configuration indicator (TCI) state, a downlink (DL) TCI state or an uplink (UL) TCI state. Using one or more of those states, the UE may transmit and receive messages to and from the new serving cell. For example, in transmitting a message to the new serving cell, the UE may apply the joint TCI state and the UL TCI state.

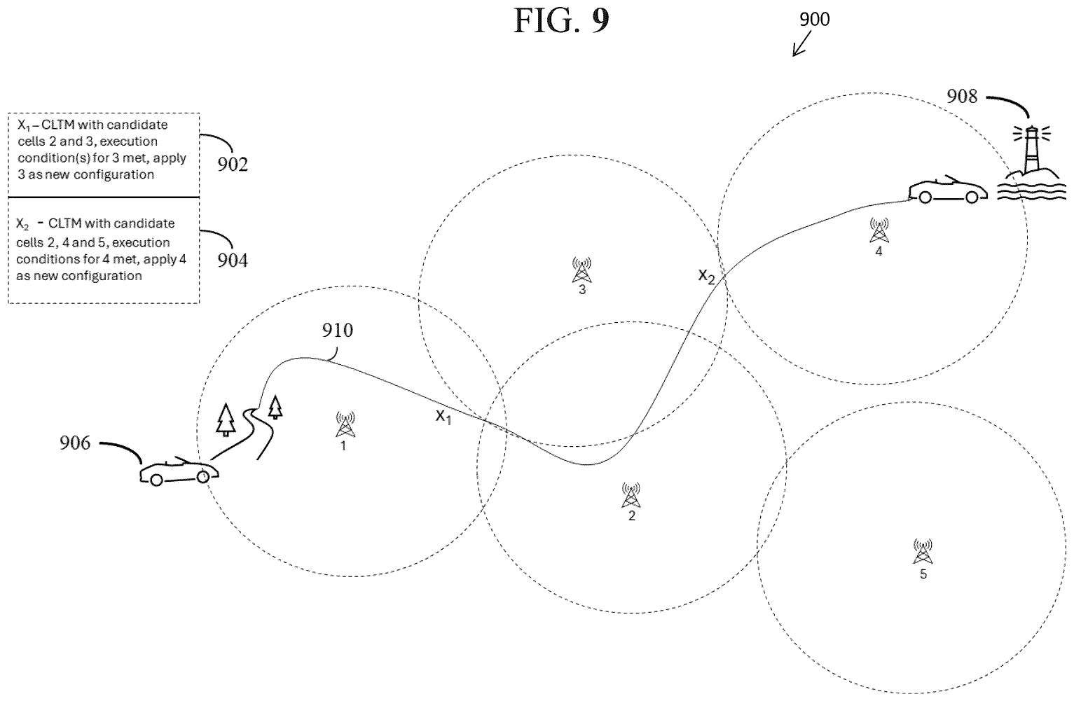

FIG. 9 shows a conceptual diagram illustrating two CLTM processes in a UE of a vehicle, in accordance with an embodiment. It is assumed that either the vehicle 906 shown at its originating point has built-in cellular capability, or a passenger in the vehicle has that capability. FIG. 9 shows a winding road 910 that traverses different 5G NR cells 1, 2, 3 and 4 prior to reaching its destination at 908. The legend on the upper left describes two CLTMs, The first CLTM 902 occurs when the vehicle 906 has reached the point demarcated x₁ on the road 910. At that point, the UE determines that the signal strength from 1 is beginning to get progressively less. The current serving cell receives this periodic measurement data from the UE. A potential CLTM 902 may be performed wherein candidate cells 2 and 3 send the UE 906 a cell configuration for each of the two cells, a physical layer (L1) measurement configuration, and for each of cells 2 and 3, at least one execution condition. Here, it is determined that even though the path 910 of the UE 906 includes a temporary entry into cell 2, the execution condition is met for cell 3 only. Accordingly, the CLTM is performed as described above and cell 3 is the new serving cell.

It is next assumed that later, the vehicle 906 reaches the point of the road 910 demarcated X₂. Accordingly, information from potential candidate cells (e.g., cells 4 and 5) is sent to the UE/vehicle 906. It is assumed that the execution condition(s) is/are triggered only for cell 4, which becomes the new serving cell. The vehicle 906 thereupon arrives at its destination. As described in legend 906, cell 4 becomes the new serving cell. It will be appreciated that the example presented is made deliberately simple to provide clarity. In actuality, there may be dozens or hundreds of cells at issue, including Pcells, Scells, PScells, and others and the road 910 may be more complex and may go through blind areas, etc. However, the basic functions applicable to CLTM described above remain, with the result being a UE-effectuated handover that accords latitude and benefits to the vehicle 906 or the UE within the same.

The CLTM procedure as disclosed herein offers numerous benefits over current methods. CLTM combines the best qualities of the conditional HO techniques, which offer greater flexibility in specifying the optimal HO cell, with the best qualities of the LTM HO, which offers speed advantages by virtue of effectuating the measurements and performing the reconfigurations and memory management at the UE. Furthermore, in many of the new embodiments, the UE is given the discretion whether to make specific selections (such as to define the new serving cell when two execution conditions corresponding to two respective cells are simultaneously met). Because the network does not perform the transfer, historical latency limitations associated with conventional HO techniques are overcome. The UE may then be equipped to provide guarantees for threshold speeds and maximum latencies. The UE also maintains a logical memory management structure in which variables are updated, modified, and deleted depending on the configuration of the cells and beams, and the L1 measurement configuration.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE), comprising:
a transceiver configured to:
receive, from a serving cell, for each of a respective one or more candidate target cells, (i) a cell configuration, (ii) at least one corresponding physical layer (L1) measurement configuration, and (iii) at least one execution condition; and
a processor operably coupled to the transceiver and configured to:
perform, using the L1 measurement configurations, L1 measurements for the respective one or more candidate target cells; and
evaluate, based on one or more of the L1 measurements, the at least one execution condition corresponding to one or more candidate target cells;
based upon evaluating that the at least one execution condition corresponding to a candidate target cell is met, determine the candidate target cell as a new serving cell;
select a beam for the new serving cell based on the one or more L1 measurements; and
detach from the serving cell and apply the cell configuration corresponding to the new serving cell;
wherein the transceiver is further configured to transmit an uplink (UL) message to the new serving cell using the selected beam.

2. The UE of claim 1, wherein when a timing advance (TA) is not obtained for the new serving cell, the transceiver is further configured to transmit the message via a random access procedure.

3. The UE of claim 1, wherein:
when a timing advance (TA) is obtained for the new serving cell, the transceiver is further configured to transmit the message using the obtained TA via a random access channel (RACH)-less procedure, and
the message is a first UL PUSCH.

4. The UE of claim 1, wherein:
the at least one execution condition comprises one or more events of:
an identified beam of the one or more evaluated candidate target cells having a measured L1 metric higher by an offset value than a beam of the serving cell;
an identified beam of the one or more evaluated candidate target cells having a measured L1 metric that exceeds a threshold; or
an identified beam of one or more of the evaluated candidate target cells having a measured L1 metric higher than a first threshold and a beam of the serving cell having a measured L1 metric lower than a second threshold, and
the measured L1 metric of the one or more evaluated candidate target cells for each of the one or more events corresponds to a value of the identified beam, or an average value of identified beams of the one or more evaluated candidate target cells.

5. The UE of claim 1, wherein the transceiver is configured to apply the selected beam for the new serving cell based upon the one or more L1 measurements that correspond to the execution condition being met for the new serving cell.

6. The UE of claim 1, wherein the transceiver is further configured to apply the selected beam for the new serving cell for use in a first downlink reception from the new serving cell.

7. The UE of claim 1, wherein:
the processor is further configured to apply one or more of a joint transmission configuration indicator (TCI) state, a downlink (DL) TCI state, or an UL TCI state;
for each of the one or more states, the reference signal is quasi-collocated to the selected beam; and
the transceiver is configured to perform one or both of (i) transmitting the (UL) message to the new serving cell based on the joint TCI state or the UL TCI state, or (ii) receiving a first DL message from the new serving cell based on the joint TCI state or the DL TCI state.

8. A method performed by a user equipment, the method comprising:
receiving, from a serving cell, for each of a respective one or more candidate target cells, (i) a cell configuration, (ii) at least one corresponding physical layer (L1) measurement configuration, and (iii) at least one execution condition;
performing, using the L1 measurement configurations, L1 measurements for the respective one or more candidate target cells;
evaluating, based on one or more of the L1 measurements, the at least one execution condition corresponding to one or more candidate target cells;
based upon evaluating that the at least one execution condition corresponding to a candidate target cell is met, determining the candidate target cell as a new serving cell;
selecting a beam for the new serving cell based on the one or more L1 measurements;
detaching from the serving cell and applying the cell configuration corresponding to the new serving cell; and
transmitting an uplink (UL) message to the new serving cell using the selected beam.

9. The method of claim 8, further comprising, when a timing advance (TA) is not obtained for the new serving cell, transmitting the message via a random access procedure.

10. The method of claim 8, further comprising, when a timing advance (TA) is obtained for the new serving cell, transmitting the message using the obtained TA via a random access channel (RACH)-less procedure, wherein the message is a first UL PUSCH.

11. The method of claim 8, wherein the at least one execution condition comprises one or more events of:
an identified beam of the one or more evaluated candidate target cells having a measured L1 metric higher by an offset value than a beam of the serving cell;
an identified beam of the one or more evaluated candidate target cells having a measured L1 metric that exceeds a threshold; or
an identified beam of one or more of the evaluated candidate target cells having a measured L1 metric higher than a first threshold and a beam of the serving cell having a measured L1 metric lower than a second threshold, and
the measured L1 metric of the one or more evaluated candidate target cells for each of the one or more events corresponds to a value of the identified beam, or an average value of identified beams of the one or more evaluated candidate target cells.

12. The method of claim 8, further comprising applying the selected beam for the new serving cell based upon the one or more L1 measurements that correspond to the execution condition being met for the new serving cell.

13. The method of claim 8, further comprising applying the selected beam for the new serving cell for use in a first downlink reception from the new serving cell.

14. The method of claim 8, further comprising:
applying one or more of a joint transmission configuration indicator (TCI) state, a downlink (DL) TCI state, or an UL TCI state, wherein for each of the one or more states, the reference signal is quasi-collocated to the selected beam; and
performing one or both of (i) transmitting the (UL) message to the new serving cell based on the joint TCI state or the UL TCI state, or (ii) receiving a first DL message from the new serving cell based on the joint TCI state of the DL TCI state.
